(19) United States
(12) Patent Application Publication
(10) Pub. No.: US 2025/0147969 A1
(43) Pub. Date: May 8, 2025

(54) DATA PROCESSING METHOD AND APPARATUS FOR USER PROFILE, DEVICE, MEDIUM, AND PROGRAM

(71) Applicant: SHENZHEN FUTU NETWORK TECHNOLOGY CO., LTD., Shenzhen (CN)

(72) Inventors: Rui CHEN, Shenzhen (CN); Shujun WANG, Shenzhen (CN); Tao YANG, Shenzhen (CN); Hongli GE, Shenzhen (CN); Xiaoyong PENG, Shenzhen (CN)

(21) Appl. No.: 19/012,914

(22) Filed: Jan. 8, 2025

Related U.S. Application Data
(63) Continuation of application No. PCT/CN2022/107564, filed on Jul. 25, 2022.

(51) Int. Cl. G06F 16/2457; G06F 21/62

(52) U.S. Cl. CPC G06F 16/2457; G06F 21/629

(57) ABSTRACT

Provided are a data processing method and a data processing apparatus based on a user profile, a device, a medium, and a program. The method includes: acquiring multiple pieces of user data and a generation time of a last piece of user data; generating, each time a piece of first user data is read from the pieces of user data, a user feature corresponding to the first user data; storing the user feature corresponding to the first user data into a target database when a generation time of the first user data is consistent with the generation time of the last piece of user data; otherwise, not storing the user feature corresponding to the first user data into the target database; and generating a user profile based on the user feature in the target database.

This application is a continuation of International Patent Application No. PCT/CN2022/107564, filed on Jul. 25, 2022, which is incorporated herein by reference in its entirety.

### FIELD

Embodiments of the present disclosure relate to the field of data processing technologies, and more particularly, to a data processing method and a data processing apparatus based on a user profile, a device, a medium, and a program.

### BACKGROUND

A user profile is a tool that describes a user and links user demands with a product design direction, which is applied to product design, precision marketing, and other fields. A server can determine user features such as behavior preferences of the user based on user data such as user gender, age, page access status, and commodity transaction status, and then generate a user profile. Therefore, user requirements can be explored based on the user profile, that is, one or more user features, and a more efficient and targeted service can be provided to the user.

A Kappa architecture is a data processing mode, which can not only process data in real-time, but also realize data playback capability based on a data retention function of its message queue, to complete offline analysis or recalculation of data. For example, when a server recalculates the user features to generate the user profile, the server can recalculate a plurality of pieces of user data stored in the message queue based on the data playback capability of the Kappa architecture. In a recalculation process, the server can sequentially read each piece of user data of the plurality of pieces of user data. When a first piece of user data is read, the server can calculate the first piece of user data to generate a user feature corresponding to the first piece of user data, and can store the user feature in a data table. When a second piece of user data is read, the server can calculate the second piece of user data to generate a user feature corresponding to the second piece of user data, and then the user feature corresponding to the first piece of user data in the data table can be updated by the server through using the user feature corresponding to the second piece of user data. In the same way, the server can complete a recalculation of the plurality of pieces of user data to obtain the user feature, thereby generating the user profile based on the user feature.

However, a data storage mode in the above calculation process can lead to an inaccurate user feature query, thus resulting in an inaccurate user profile generated based on a queried user feature. For example, when the user feature is queried in the recalculation process and the server has not completed the recalculation of the plurality of pieces of user data, in this case, the queried user feature will not be the user feature calculated based on the plurality of pieces of user data, which further results in an inaccurate query result, thus causing certain influence on a generation and application of the user profile.

### SUMMARY

The present disclosure provides a data processing method and a data processing apparatus based on a user profile, a device, a medium, and a program to solve a problem in the related art of inaccurate user feature query caused by data storage and an inaccurate user profile generated based on a queried user feature. Therefore, the accuracy of the user feature query can be improved, and the accuracy of generated user profile can be further improved, thereby improving the efficiency and accuracy of an application of the user profile.

In a first aspect, the present disclosure provides a data processing method based on a user profile. The method includes: acquiring a plurality of pieces of user data and a generation time of a last piece of user data among the plurality of pieces of user data; generating, each time a piece of first user data is read from the plurality of pieces of user data, a user feature corresponding to the first user data; storing the user feature corresponding to the first user data into a target database when a generation time of the first user data is consistent with the generation time of the last piece of user data; not storing the user feature corresponding to the first user data into the target database when the generation time of the first user data is inconsistent with the generation time of the last piece of user data; and generating a user profile based on the user feature in the target database.

In a second aspect, the present disclosure provides a data processing apparatus based on a user profile. The apparatus includes a first acquiring module, a generating module, a processing module and a second generating module. The first acquiring module is configured to acquire a plurality of pieces of user data and a generation time of a last piece of user data among the plurality of pieces of user data. The generating module is configured to generate, each time a piece of first user data is read from the plurality of pieces of user data, a user feature corresponding to the first user data. The processing module is configured to: store the user feature corresponding to the first user data into a target database when a generation time of the first user data is consistent with the generation time of the last piece of user data; and not store the user feature corresponding to the first user data into the target database when the generation time of the first user data is inconsistent with the generation time of the last piece of user data. The second generating module is configured to generate a user profile based on the user feature in the target database.

In a third aspect, an electronic device is provided. The electronic device includes a memory configured to store a computer program, and a processor configured to invoke and execute the computer program stored in the memory to perform the method in the first aspect or implementations thereof.

In a fourth aspect, a computer-readable storage medium is provided. The medium has a computer program stored thereon. The computer program causes a computer to perform the method in the first aspect or implementations thereof.

In a fifth aspect, a computer program product is provided. The computer program product includes a computer program instruction. The computer program instruction causes a computer to perform the method in the first aspect or implementations thereof.

In a sixth aspect, a computer program is provided. The computer program causes a computer to perform the method in the first aspect or implementations thereof.

According to a technical solution of the present disclosure, a server can first acquire the plurality of pieces of user data and the generation time of the last piece of user data among the plurality of pieces of user data. Each time a piece of first user data is read from the plurality of pieces of user data, the server can generate the user feature corresponding to the first user data. When the generation time of the first user data is consistent with the generation time of the last piece of user data, the server can store the user feature corresponding to the first user data into the target database. When the generation time of the first user data is inconsistent with the generation time of the last piece of user data, the server may not store the user feature corresponding to the first user data into the target database. Finally, the server can generate the user profile based on the user feature in the target database. In the above process, the server can determine whether a currently read user data is the last piece of user data by determining whether a generation time of the currently read user data is consistent with the generation time of the last piece of user data. Therefore, only the user feature corresponding to the last piece of user data may be stored in the target database, and a user feature corresponding to other user data may not be stored in the target database. Then, in response to querying the user feature, such as querying the user feature when the server reads the user data, a query result will not be the user feature corresponding to other user data, but only a user feature corresponding to a last piece of original user data, that is, a final user feature calculated based on all user data. In this way, the server can generate a correct user profile based on the final user feature to solve the problem in the related art of inaccurate user feature query caused by data storage and the inaccurate user profile generated based on the queried user feature. Therefore, the accuracy of the user feature query can be improved, and the accuracy of the generated user profile can be further improved, thereby improving the efficiency and accuracy of the application of the user profile.

### BRIEF DESCRIPTION OF THE DRAWINGS

In order to clearly explain technical solutions of embodiments of the present disclosure, drawings used in the description of the embodiments or the related art are briefly described below. The drawings as described below are merely some embodiments of the present disclosure. Based on these drawings, other drawings can be obtained by those skilled in the art without creative effort.

FIG. 1 is an application scenario diagram according to an embodiment of the present disclosure.

FIG. 2 is a flowchart of a data processing method based on a user profile according to an embodiment of the present disclosure.

FIG. 3 is a schematic diagram of data processing based on user profile according to an embodiment of the present disclosure.

FIG. 4 is a schematic diagram of another data processing based on a user profile according to an embodiment of the present disclosure.

FIG. 5 is a schematic diagram of another data processing based on a user profile according to an embodiment of the present disclosure.

FIG. 6 is a schematic diagram of another data processing based on a user profile according to an embodiment of the present disclosure.

FIG. 7 is a schematic diagram of another data processing based on a user profile according to an embodiment of the present disclosure.

FIG. 8 is a schematic diagram of another data processing based on a user profile according to an embodiment of the present disclosure.

FIG. 9 is a schematic diagram of another data processing based on a user profile according to an embodiment of the present disclosure.

FIG. 10 is a schematic diagram of a data processing apparatus 1000 based on a user profile according to an embodiment of the present disclosure.

FIG. 11 is a schematic block diagram of an electronic device according to an embodiment of the present disclosure.

### DETAILED DESCRIPTION

Technical solutions according to embodiments of the present disclosure will be described clearly and completely below in combination with accompanying drawings of the embodiments of the present disclosure. Obviously, the embodiments described below are only a part, rather than all, of the embodiments of the present disclosure. On a basis of the embodiments in the present disclosure, all other embodiments obtained by a those of ordinary skill in the art without creative labor shall fall within the scope of the present disclosure.

It should be noted that terms such as “first”, “second”, and the like, in the description, the claims, and the accompanying drawings of the present disclosure, are used to distinguish between similar objects, rather than to describe a particular order or sequence. It should be understood that data used in this way may be interchanged with each other under appropriate circumstances, such that the described embodiments of the present disclosure can be implemented in a sequence other than those illustrated or described in the present disclosure. In addition, terms “include”, “have”, and any variations thereof are intended to cover non-exclusive inclusions. For example, a process, method, system, product, or server that includes a series of steps or units is not necessarily limited to those clearly listed steps or units, but may also include other steps or units that are not clearly listed or are inherent to the process, method, product, or device.

As described above, when a server recalculates a user feature to generate a user profile, the server can recalculate a plurality of pieces of user data stored in its message queue based on data playback capability of a Kappa architecture. In a recalculation process, the server can sequentially read each piece of user data of the plurality of pieces of user data. When a first piece of user data is read, the server can calculate the first piece of user data to generate a user feature corresponding to the first piece of user data, and can store the user feature in a data table. When a second piece of user data is read, the server can calculate the second piece of user data to generate a user feature corresponding to the second piece of user data, and then the user feature corresponding to the first piece of user data in the data table can be updated by the server through using the user feature corresponding to the second piece of user data. In the same way, the server can complete a recalculation of the plurality of pieces of user data. However, a data storage mode in the above calculation process can result in an inaccurate user feature query, thus resulting in an inaccurate user profile generated based on a queried user feature. For example, when the user feature is queried in the recalculation process and the server has not completed the recalculation of the plurality of pieces of user data, in this case, the queried user feature will not be the user feature calculated based on the plurality of pieces of user data, which further results in an inaccurate query result, thus causing certain influence on a generation and application of the user profile.

To solve the above technical problem, the server can first acquire the plurality of pieces of user data and the generation time of the last piece of user data among the plurality of pieces of user data. Each time a piece of first user data is read from the plurality of pieces of user data, the server can generate the user feature corresponding to the first user data. When the generation time of the first user data is consistent with the generation time of the last piece of user data, the server can store the user feature corresponding to the first user data into the target database. When the generation time of the first user data is inconsistent with the generation time of the last piece of user data, the server may not store the user feature corresponding to the first user data into the target database. Finally, the server can generate the user profile based on the user feature in the target database. In the above process, the server can determine whether a currently read user data is the last piece of user data by determining whether a generation time of the currently read user data is consistent with the generation time of the last piece of user data. Therefore, only the user feature corresponding to the last piece of user data may be stored in the target database, and a user feature corresponding to other user data may not be stored in the target database. Then, in response to querying the user feature, such as querying the user feature when the server reads the user data, a query result will not be the user feature corresponding to other user data, but only a user feature corresponding to a last piece of original user data, that is, a final user feature calculated based on all user data. In this way, the server can generate a correct user profile based on the final user feature to solve the problem in the related art of inaccurate user feature query caused by data storage and the inaccurate user profile generated based on the queried user feature. Therefore, the accuracy of the user feature query can be improved, and the accuracy of the generated user profile can be further improved, thereby improving the efficiency and accuracy of the application of the user profile.

It should be understood that the technical solutions of the present disclosure may be applied to the following scenarios, but is not limited thereto.

In some implementations, FIG. 1 is an application scenario diagram according to an embodiment of the present disclosure. As shown in FIG. 1, the application scenario can include a terminal 110 and a server 120. The terminal 110 and the server 120 can be in communication with each other.

By way of example, the server 120 can recalculate the plurality of pieces of user data stored in its message queue based on the data playback capability of the Kappa architecture to obtain the user feature, and store the user feature in the database, to generate the user profile based on the user feature in the database. The database may be a database in the server 120 or a database inside the server 120, and the present disclosure is not limited thereto. For example, the server 120 may be a data middle platform. When the user profile needs to be reconstructed, such as when a calculation caliber of user data for stock account opening changes, the data middle platform can re-acquire user data in the message queue, and determine a new user feature to re-generate a user profile. A user feature query client may be mounted at the terminal 110, and the user queries the above user feature based on natural language by accessing the user feature query client. Alternatively, the user feature query client may not be mounted at the terminal 110, and the user queries the above user feature based on natural language through a browser. When querying, the server 120 can convert the natural language into a Structured Query Language (SQL) corresponding to the natural language, and queries the user feature stored in the above database based on the SQL corresponding to the natural language, to return the query result to the terminal 110.

In some implementations, the terminal 110 may be a mobile phone, a tablet computer, a desktop computer, a laptop computer, a handheld computer, a notebook computer, a vehicle-mounted device, an Ultra-Mobile Personal Computer (UMPC), a netbook, a cellular phone, a Personal Digital Assistant (PDA), an Augmented Reality (AR)/Virtual Reality (VR) device, which is not limited by the present disclosure. The server 120 may be an independent physical server, a server cluster, a distributed system composed of a plurality of physical servers, or a cloud server providing a cloud computing service, which is not limited by the embodiments of the present disclosure.

It should be understood that the number of terminals and servers in FIG. 1 is only illustrative, and in fact, any number of terminals and servers may be provided based on actual needs, which is not limited by the present disclosure.

In response to introducing the application scenario of the embodiments of the present disclosure, the technical solutions of the present disclosure will be described in detail as follows.

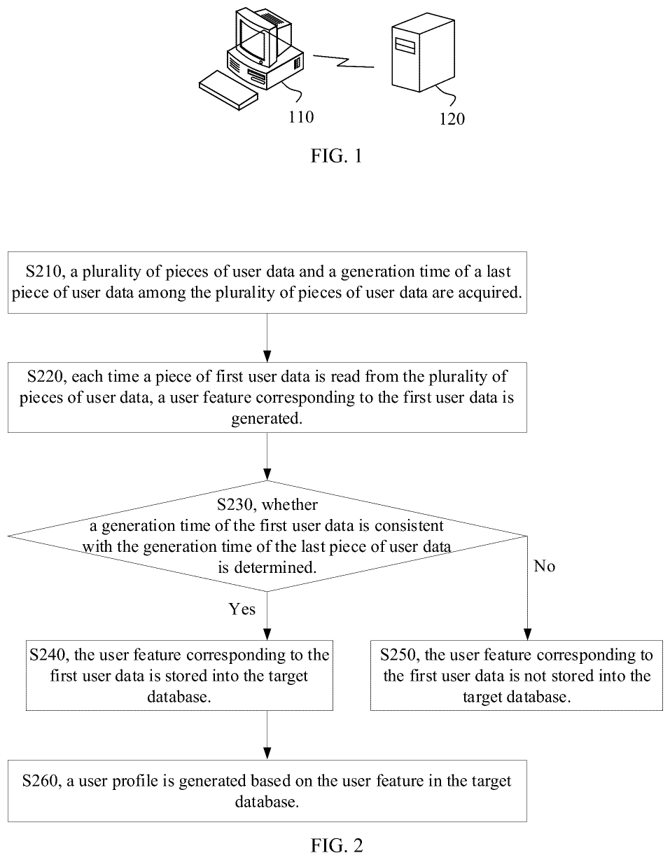

FIG. 2 is a flowchart of a data processing method based on a user profile according to an embodiment of the present disclosure. The method can be executed by the server 120 as shown in FIG. 1, which is not limited by the present disclosure. As shown in FIG. 2, the method may include operation at the following blocks.

At block S210, a plurality of pieces of user data and a generation time of a last piece of user data among the plurality of pieces of user data are acquired.

At block S220, each time a piece of first user data is read from the plurality of pieces of user data, a user feature corresponding to the first user data is generated.

At block S230, whether a generation time of the first user data is consistent with the generation time of the last piece of user data is determined. When the generation time of the first user data is consistent with the generation time of the last piece of user data, an operation at block S240 is executed. When the generation time of the first user data is inconsistent with the generation time of the last piece of user data, an operation at block S250 is executed.

At block S240, the user feature corresponding to the first user data is stored into the target database.

At block S250, the user feature corresponding to the first original data is not stored into the target database.

At block S260, a user profile is generated based on the user feature in the target database.

It should be understood that the above steps are steps performed by the server during data playback. For example, the above steps may be steps performed when the server recalculates the plurality of pieces of user data based on the data playback capability of the Kappa architecture to generate a user profile. It should be noted that the Kappa architecture includes a message queue, a stream processing cluster, and a data table. The message queue has a data retention function and can store user data. During data playback, the stream processing cluster can read user data in the message queue. Since Kafka is a message system with historical data preservation and historical data playback functions, Kafka can be selected as a message queue. The stream processing cluster can calculate the user data read from the message queue to obtain the user feature corresponding to the user data. Since Flink is a computing framework that supports stream batch processing, Flink can be selected as the stream processing cluster. The data table can be used to store a user feature corresponding to user data calculated by the stream processing cluster.

By way of example, in the present disclosure, a case, where the server recalculates the plurality of pieces of user data based on the data playback capability of the Kappa architecture to generate the user profile, is taken as an example, the above steps are briefly introduced. First, the server can obtain the plurality of pieces of user data from other databases and store the plurality of pieces of user data in the message queue. When the server needs to recalculate the plurality of pieces of user data stored in the message queue based on the data playback capability of the Kappa architecture, the server can obtain the generation time of the last piece of user data among the plurality of pieces of user data. When a version or the generation time of the data is smaller than a stored version, the data in this process is filtered or deleted to ensure that the data is written correctly. In an exemplary embodiment of the present disclosure, the server can sequentially read the plurality of pieces of user data stored in the message queue based on the stream processing cluster. When the first piece of user data is read, the stream processing cluster can calculate the first piece of user data to generate the user feature corresponding to the first piece of user data, and determine that the generation time of the first piece of user data is inconsistent with the generation time of the last piece of user data. Then the server will not store the user feature corresponding to the first piece of user data in the data table, that is, the above-mentioned target database. Next, the server can read the second piece of user data stored in the message queue based on the stream processing cluster. The stream processing cluster can calculate the second piece of user data to generate the user feature corresponding to the second piece of user data, and determine whether the generation time of the second piece of user data is inconsistent with the generation time of the last piece of user data. When the generation time of the second piece of user data is consistent with the generation time of the last piece of user data, the server can determine that the second piece of user data is the last piece of user data, and the server can determine that the user feature corresponding to the second piece of user data is the user feature corresponding to the last piece of user data. Then the server can store the user feature in the data table. When the generation time of the second piece of user data is inconsistent with the generation time of the last piece of user data, the server can determine that the second piece of user data is not the last piece of user data, and the server may not store the user feature corresponding to the second piece of user data in the data table. Similarly, for other pieces of user data, the server can perform steps similar to those for the second piece of user data. In this way, when the terminal performs the user feature query, the query result will only be the user feature corresponding to the last piece of user data, i.e., the latest user data, and will not be the user feature corresponding to other pieces of user data. Therefore, the query result is accurate, thereby solving the problem that the user profile generated based on the queried user feature is inaccurate due to the inaccurate user feature query caused by data storage in the related art, improving the accuracy of a user feature query, and further improving the efficiency and accuracy of the application of the user profile.

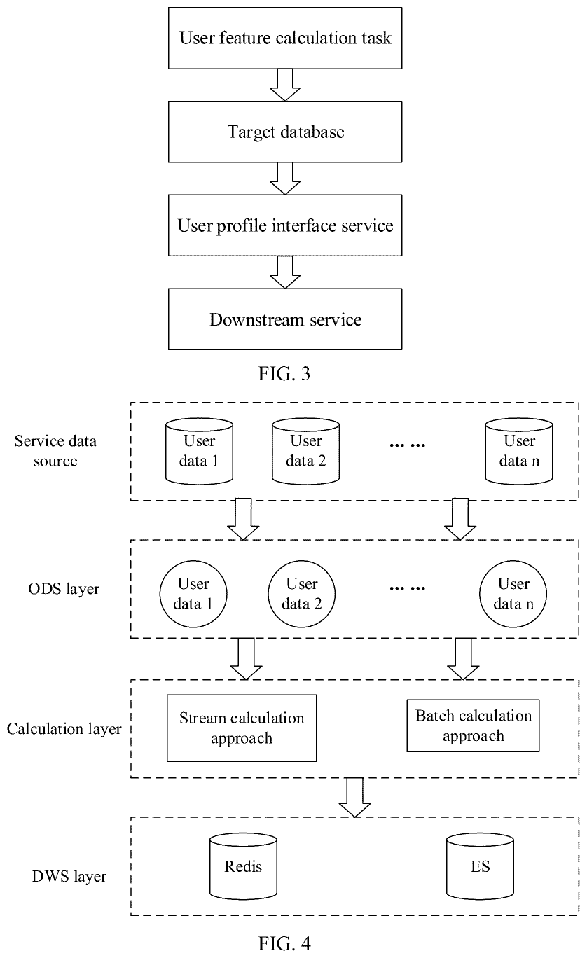

It should be noted that, as shown in FIG. 3, when the server constructs the user profile, user features such as user behavior preferences may be determined based on user data such as user gender, age, page access status, commodity transaction status, and the like, and then the user profile can be constructed. Therefore, user requirements can be discovered based on the user profile, i.e., one or more user features, and a more efficient and targeted service can be provided to the user. The user feature can be stored in the target database, and when discovering user requirements based on the user feature, the corresponding user feature can be queried through a user profile interface service to apply the queried user feature to a downstream service, such as product design, precision marketing, etc.

In the following embodiments, the technical solution of the present disclosure will be described by taking the server being the data middle platform as an example. It should be noted that, in the following embodiments, user data is acquired and calculated based on data compliance, and the acquired user data is authorized by the user. The user data, the user feature, and the like are encrypted and protected.

In some implementations, it is assumed that the user feature to be determined by the data middle platform is the number of stock account opening holders, and the user data to be used to determine the user feature is a user stock account opening status. The data middle platform can calculate the user data based on the Kappa architecture to determine the user feature. The message queue of the Kappa architecture is Kafka, and the stream processing cluster is Flink. The target database storing the user feature is the data table. When the data middle platform needs to recalculate the user feature based on the user data, for example, in a case that the data middle platform determines the number of stock account opening holders previously, a calculation caliber is: counting the number of pieces of user data whose account status is already opened in the user data; however, in a case that the data middle platform determines the number of stock account holders currently, the calculation caliber changes as follows: counting the number of pieces of user data whose account status is either already opened or under review, therefore, in this case, the data middle platform needs to re-determine the user feature being the number of stock account opening holders. The specific process is as follows. Firstly, the data middle platform can acquire a plurality of pieces of user data about user stock account opening status from other databases, such as a service source database that records user data such as user stock account opening status, and the data middle platform can store the plurality of pieces of user data in Kafka. It is assumed that there are three pieces of user data about user stock account opening status acquired by the data middle platform. The first piece of user data is that an account opening status of a stock 1 by a user 1 at 13:22 on Jun. 30, 2022 is already opened. The second piece of user data is that an account opening status of the stock 1 by a user 2 at 13:23 on Jun. 30, 2022 is under review. The third piece of user data is that an account opening status of a stock 2 by a user 3 at 13:30 on Jun. 30, 2022 is not opened. Then, the data middle platform can obtain the generation time of the last piece of user data among the plurality of pieces of user data, that is, the generation time of the third piece of user data at 13:30 on Jun. 30, 2022. Then, the data middle platform can read the above three pieces of user data from Kafka based on Flink. When the first piece of user data is read, Flink can determine that the user feature corresponding to the first piece of user data, i.e., the number of stock account opening holders, is 1, and can determine that the generation time of the first piece of user data is at 13:22 on Jun. 30, 2022, which is inconsistent with the generation time of the last piece of user data at 13:30 on Jun. 30, 2022. Thus, the data middle platform will not store the user feature corresponding to the first piece of user data in the data table. Then the data middle platform can read the second piece of user data from Kafka based on Flink, Flink can determine that the user feature corresponding to the second piece of user data is 2, and can determine that the generation time of the second piece of user data is at 13:23 on Jun. 30, 2022, which is inconsistent with the generation time of the last piece of user data at 13:30 on Jun. 30, 2022. Thus, the data middle platform will not store the user feature corresponding to the second piece of user data in the data table. Finally, the data middle platform can read the third piece of user data from Kafka based on Flink, Flink can determine that the user feature corresponding to the third piece of user data is 2, and can determine that the generation time of the third piece of user data is at 13:30 on Jun. 30, 2022, which is consistent with the generation time of the last piece of user data at 13:30 on Jun. 30, 2022. Thus, the data middle platform can store the user feature corresponding to the third piece of user data in the data table. Therefore, the data middle platform can determine that the following user feature: the number of stock account opening holders is 2. Then, for a query request for querying the user feature received in the above process of calculating the user feature again, a returned query result will only be the user feature calculated based on the last piece of user data, i.e., the number of stock account opening holders is 2. Since the user feature calculated based on other user data is not stored in the data table, the query result will not be the user feature calculated based on other user data, e.g., the number of stock account opening holders is 1. Therefore, the accuracy of the user feature query can be improved, and the accuracy and efficiency of the generated user profile can be improved.

In some implementations, as shown in FIG. 4, when constructing the user profile, the data middle platform can first acquire user data from other databases such as service data sources through Binlog synchronization or Agent reporting, and the user data can include user data such as user stock account opening status and user login status. The acquired user data can be placed in an Operation Data Store (ODS) layer, and the ODS layer is a layer in a data model that is closest to the original data in the data source, i.e., user data, and generally can access the original data in the data source intactly. Binlog synchronization is a way for the data middle platform to obtain user data from the other databases and store it in the ODS layer. Agent reporting is a way for the other databases to actively send user data to the ODS layer. In addition, Binlog synchronization includes Changelog. The data middle platform can capture changed data in other databases in real-time through Changelog and synchronize the changed data to the ODS layer. For example, following piece of user data is recorded in other databases: the account opening status of the stock 1 by the user 2 is under review, and the data middle platform can acquire this piece of user data from other databases through Binlog synchronization and store it in the ODS layer. At this time, the user data stored in the ODS layer is that the account opening status of the stock 1 by the user 2 is under review. After that, the user data recorded in other databases is changed to: when the account opening status of the stock 1 by the user 2 is already opened, the data middle platform can capture the changed data, i.e., “already opened”, in real-time through Changelog. Then the data middle platform can synchronize the changed data to the ODS layer, i.e., the user data stored in the ODS layer is changed from “under review” to “already opened” for the account opening status of the stock 1 by the user 2. In this way, data transmission overhead can be reduced and transmission efficiency can be improved. After that, the data middle platform can calculate the user data of the ODS layer at a calculation layer to determine the user feature, and a calculation approach may be a stream calculation approach or a batch calculation approach. A specific calculation process will be described in detail in the following embodiments, and will not be described herein. Next, the data middle platform can store the user feature in a Data Warehouse Service (DWS) layer, which may then generate the user profile. The DWS layer can be used to store a calculation result, such as the calculation result for the user data in the ODS layer. It can be understood that in the calculation of the user data based on the Kappa architecture performed by the data middle platform, Kafka may be used as the ODS layer, and the data table may be used as the DWS layer.

In some implementations, the server generates the user feature corresponding to the first user data each time a piece of the first user data is read from the plurality of pieces of user data, the server can first select a generation approach for the user feature corresponding to the first user data based on a calculation caliber and the application scenario. The generation approach is a stream generation approach or a batch generation approach. Then, the server can generate the user feature corresponding to the first user data based on the generation approach for the user feature corresponding to the first user data. The data middle platform can complete the stream generation approach, i.e., the stream calculation approach, based on the Kappa architecture, and can trigger the batch generation approach, i.e., the batch calculation approach, at regular intervals through Airflow, or can trigger the batch generation approach at regular intervals through other approaches, which is not limited by the present disclosure. Airflow is a task scheduling tool, which can set a trigger time for calculation tasks, such as batch calculation tasks, and an execution duration for calculation tasks, such as batch calculation tasks. It should be noted that the server can complete the stream generation approach based on the Kappa architecture, and can further complete the stream generation approach based on a Lambda architecture, which is not limited by the present disclosure. The Lambda architecture is a kind of data processing architecture that includes two modules of real-time processing, i.e. stream calculation, and offline processing, i.e. batch calculation. Thus, a maintenance cost is relatively high. However, the Kappa architecture has no offline processing module, i.e. batch calculating module, allowing the maintenance cost of the stream generation approach based on the Kappa architecture to be reduced.

It should be understood that the batch generation approach, i.e., the batch calculation approach, is a batch, high-latency, initiative-initiated calculation approach. The batch calculation approach must first define a calculation job logic and submit it to an attrition calculation system. The calculation job logic cannot be changed during a whole operation period. Data calculated by the batch calculation approach must be loaded into the calculation system in advance, and the subsequent calculation system will perform calculation after the data loading is completed. Different from the batch calculation approach, the stream generation approach, i.e., the stream calculation approach, places more emphasis on calculation data streams and low latency. The stream calculation approach can spread a large amount of data to each time point, and continuously carry out small batch transmission. Thus, data flows continuously, and the data is discarded after calculation. The results obtained by the stream calculation approach can be immediately delivered to an online system to achieve a real-time display.

By way of example, it is assumed that a user feature 1 to be determined is: the number of times that the user 1 browses a page 1 within 10 days before 13:30 on May 30, 2022. An application scenario 1 of the user feature 1 is: predicting the number of times that the user 1 browses the page 1 within 10 days after 13:30 on May 30, 2022 based on the user feature 1, to determine whether an actual number of times that the user 1 browses the page 1 within 10 days after 13:30 on May 30, 2022 is consistent with the predicted number of times. A calculation criterion 1 for determining the user feature 1 is: acquiring browsing data that the user 1 browses all pages within 10 days before 13:30 on May 30, 2022, and then counting the number of browsing the page 1 in the browsing data. Based on the application scenario 1 and the calculation caliber 1 corresponding to the user feature 1, it can be determined that a real-time requirement for determining the user feature 1 is not high. Therefore, the data middle platform can select the generation approach of the user feature 1 as the batch generation approach, i.e., the batch calculation approach. For example, the data middle platform can set a start time of generating the user feature 1 through Airflow, such as 13:30 on Jun. 30, 2022, and then obtain, at the start time, browsing data that the user 1 browses all pages within 10 days before 13:30 on May 30, 2022. Then, the data middle platform can use the batch calculation approach for browsing the data to count the browsing times of the page 1 in the browsing data, thereby determining the user feature 1.

By way of example, it is assumed that a user feature 2 to be determined is: whether the user 2 has logged in to an application 1 in the past three days. An application scenario 2 of the user feature 2 is: determining whether the user 2 is an active user based on the user feature 2. In response to determining that the user 2 is an active user, a message 1 is pushed to the user 2 in real-time, and in response to determining that the user 2 is not an active user, the message 1 is not pushed to the user 2. A calculation caliber 2 of the user feature 2 is: acquiring data of the last time login of the user 2 to the application 1, and determining whether the generation time of the data is within the last three days. When the generation time of the data is within the last three days, it is determined that the user feature 2 is “1”, and when the generation time of the data is not within the last three days, it is determined that the user feature 2 is “0”. Based on the application scenario 2 and the calculation caliber 2 corresponding to the user feature 2, it can be determined that a real-time requirement for determining the user feature 2 is relatively high. Thus, the data middle platform can select the generation approach of the user feature 2 as the stream generation approach, i.e., the stream calculation approach. For example, it is assumed that the data middle platform needs to determine whether to push the message 1 to the user 2 at 13:30 on Jun. 30, 2022, then the data middle platform can acquire data of the last time login of the user 2 to the application 1 in real-time. When the user 2 logs in to the application 1 at 12:30 on Jun. 30, 2022, and it can be determined that the generation time of the data is within the last three days, then it can be determined that the user feature is “1”. That is, it can be determined that the user 2 is the active user, and the message 1 can be pushed to the user 2 in real-time.

In some implementations, as shown in FIG. 4, the target database in this embodiment may include, but is not limited to, a Remote Dictionary Server (Redis) database, an ElasticSearch database, and a cloud database. When the data middle platform stores the user feature in the DWS layer (target database), the user feature can be stored in a database such as the Redis database, the ElasticSearch database, or a cloud server.

It should be understood that the Redis database adopts a key-value storage mode, that is, each record only contains a Key used for querying data and a value of corresponding stored data. Therefore, for query interfaces with higher real-time requirements and smaller query data volume, such as On-Line Transaction Processing (OLTP), the Redis database is generally chosen as the query engine. The ElasticSearch database can realize high-performance complex aggregation query. Therefore, for query interfaces with lower real-time requirements and larger query data volume, such as On-Line Analytical Processing (OLAP), the ElasticSearch database is generally chosen as the query engine. The cloud storage is suitable for data with a large amount, a wide range of coverage, and high real-time requirements. In an exemplary embodiment of the present disclosure, in response to determining a storage mode of a data packet, data parameters of the data packet are first acquired in this embodiment, and the data parameters can include a query frequency Dat_fre corresponding to a data name, a data amount Dat_voe corresponding to the data packet, and a data priority Dat pro corresponding to the data name. Then, an attribute parameter Dat_pre corresponding to the data packet is determined based on the data parameters as follows:

$$Dat\_pre = \{ \begin{matrix}α \cdot Dat\_pro \cdot ( Dat\_fre + γ \cdot {log}_{2} Dat\_voe ) ; Dat\_fre \geq Dat\_mon \\ ϵ \cdot Dat\_pro \cdot Dat\_fre + γ \cdot {log}_{2} Dat\_voe ; Dat\_fre < Dat\_mon\end{matrix}$$

where α, γ, and ϵ represent attribute factors obtained by training based on historical data, Dat_mon represents a predetermined frequency threshold. A query frequency is determined based on the frequency threshold, to determine a corresponding attribute parameter determination mode in a targeted manner. In this embodiment, the query frequency, priority, and data volume of the data are considered for calculating the attribute parameters, and the storage mode of the data packet is determined based on the parameters. Then, a storage location corresponding to the data packet is determined based on the attribute parameters. More particularly, parameter thresholds corresponding to each storage mode can be predetermined, and the storage location corresponding to the data packet is determined based on the parameter thresholds corresponding to each storage mode. Therefore, a personalized storage of the data storage is ensured in the above manner, thereby improving the efficiency of the data storage and the data calling, and reducing the cost of the data storage.

Subsequent to the user feature being stored in a storage medium such as the Redis database, the ElasticSearch database, and the cloud server, the data middle platform can select and determine a query interface corresponding to the query request based on the query request. Therefore, when different query interfaces perform query based on an appropriate database, it can be ensured that databases corresponding to different query interfaces all store user features, thereby improving the query efficiency. A specific implementation manner in which the data middle platform can select and determine the query interface corresponding to the query request based on the query request will be described in detail in the following embodiment, which will not be repeated herein by the present disclosure.

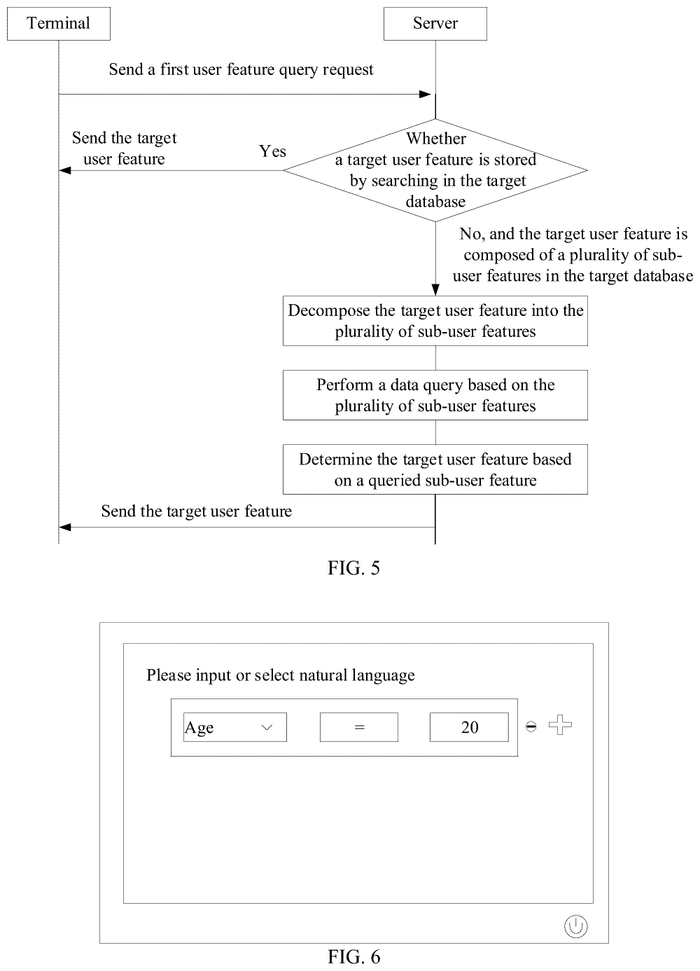

In some implementations, as shown in FIG. 5, the terminal can send a first user feature query request to the server, and subsequent to the first user feature query request being received, the server can determine whether a target user feature is stored by searching in the target database in response to the first user feature query request. When the target user feature is stored in the target database, the server can send the target user feature to the terminal. When the target user feature is not stored in the target database and the target user feature is composed of a plurality of sub-user features in the target database, the server can decompose the target user feature into the plurality of sub-user features, and perform a data query based on the plurality of sub-user features. Finally, the server can determine the target user feature based on a queried sub-user feature, and send the target user feature to the terminal. That is, the server can further perform a combination determination by using the plurality of user features. In this way, the server does not need to generate the target user feature, and the target database only needs to store the sub-user features. That is, the target database can only store sub-user features, and when the server receives the first query request, the server can determine the target user feature based on the sub-user features, thereby reducing a calculation cost of the server and a storage cost of the target database, i.e., reducing the redundancy and duplication of a development cost of user profile data. In addition, in the above process, the server can realize a combination determination of the user feature based on a query of the plurality of sub-user features, that is, the server can realize the combination determination by using the plurality of user features. Therefore, the processing capability of the server is improved, and the user experience is improved.

By way of example, it is assumed that the target user feature to be queried by the terminal is: a user who has logged in to the application 1 in the last three days and whose account opening status for the stock 1 is already opened. The target database does not store the target user feature, and the target database stores a sub-user feature 1 and a sub-user feature 2, which are respectively: the user who has logged in to the application 1 in the last three days, and the user whose account opening status for the stock 1 is already opened. Subsequent to the server receiving the first user feature query request sent by the terminal, the server can search the target database for the target user feature, and determine that the target user feature is not stored in the target database. The server can determine that the target user feature can be composed of an intersection of the sub-user feature 1 and the sub-user feature 2. Then, the server can search the target database for the sub-user feature 1 and the sub-user feature 2, and determine that the sub-user feature 1 is “the user 1, the user 2, and the user 3” and the sub-user feature 2 is “the user 1, and the user 2”. Therefore, the server can determine that the target user feature is “the user 1, and the user 2,” and then send the determined target user feature to the terminal. In response to determining that the target user feature is not stored in the target database and that the target user feature can be composed of the plurality of sub-user features stored in the target database, the server can query the target database for the plurality of sub-user features based on an AST and determine the target user feature based on the plurality of sub-user features. The AST is transformed from codes related the plurality of sub-user features, and a composition relationship for constituting the target user feature using the plurality of sub-user features.

In some implementations, subsequent to the first user feature query request sent by the terminal being received, the server can convert, in response to the first user feature query request, the first user feature query request into a second user feature query request with a same meaning as the first user feature query request. Then, in response to the second user feature query request, the server can determine whether the target user feature is stored by searching in the target database. In this way, when the server does not find the user feature corresponding to the first user feature query request in the target database, the server can search the target database for the corresponding user feature based on the second user feature query request with the same meaning as the first user feature query request. When the user feature corresponding to the second user feature query request is stored in the target database, the server can send the user feature corresponding to the second user feature query request to the terminal. Therefore, the query efficiency can be improved, and the generation efficiency of the user profile can be improved.

By way of example, it is assumed that the target database does not store the user feature 1: whether the user 1 has logged in the application 1 in the last three days, and the target database stores the user feature 2: a last login time of the user 1 to the application 1 is within the last three days, and the first user feature query request sent by the terminal to the server is used to query the user feature 1 in the target database. In response to receiving the first user feature query request, the server can, in response to the first user feature query request, convert the first user feature query request into the second user feature query request with the same meaning as the first user feature query request. The second user feature query request is used to search the target database for the user feature 2. Then, the server can search the target database for the user feature 2 in response to the second user feature query request, and send the found user feature 2 to the terminal. The server can pre-store a correspondence relationship between the second user feature query request and the first user feature query request with the same meaning as the second user feature query request. When the first user feature query request is converted into the second user feature query request, a conversion can be performed based on the stored correspondence relationship, which is not limited by the present disclosure. In addition, in response to receiving the first user feature query request, the server can query the target database for the user feature 1 corresponding to the first user feature query request in response to the first user feature query request. Then, the server can convert the first user feature query request into the second user feature query request when the user feature 1 is not found, and determine whether the user feature 2 is stored in the target database in response to the second user feature query request, which is not limited by the present disclosure.

In some implementations, prior to determining, in response to the first user feature query request, whether the target user feature is stored by searching in the target database, the server can further perform a permission verification on a sender of the first user feature query request. When the permission verification on the sender passes, the server can determine, in response to the first user feature query request, whether the target user feature is stored by searching in the target database, thereby improving the security of the data query, and improving the security of generating the user profile.

By way of example, prior to determining, in response to the first user feature query request, whether the target user feature is stored by searching in the target database, the server can acquire an identifier of the sender, and then determine a permission range of the sender based on the identifier of the sender. When the permission range of the sender includes permission to query the target user feature, the server can determine that the permission verification on the sender passes. When the permission range of the sender does not include the permission to query the target user feature, the server can determine that the permission verification on the sender fails. The server can pre-store a corresponding relationship between the identifier of the sender and the permission range of the sender, and the permission range of the sender includes the user feature that the sender can search in the target database. For example, it is assumed that the first user feature query request is used to query the user feature 1 in the target database, and the server pre-stores a corresponding relationship between an identifier of a service party 1 and a permission range 1 of the service party 1. It is assumed that the permission range 1 includes the user feature 1, and the user feature 2. In response to receiving the first user feature query request sent by the terminal, the server can first determine that the identifier of the sender of the first user feature query request is a sender 1, and then the server can find out that a permission range of the sender 1 includes the user feature 1 in the correspondence stored in advance. Therefore, the server can determine that the permission verification on the sender 1 passes.

In some implementations, prior to determining, in response to the first user feature query request, whether the target user feature is stored by searching in the target database, the server can further determine a query interface corresponding to the first user feature query request, and then can determine, in response to the first user feature query request and based on the query interface corresponding to the first user feature query request, whether the target user feature is stored by searching in the target database. For example, in response to determining the query interface corresponding to the first user feature query request, the server can first determine whether the first user feature query request includes the user identifier. The server can determine that the query interface corresponding to the first user feature query request is an OLTP interface when the first user feature query request includes a user identifier. The server can determine that the query interface corresponding to the first user feature query request is an OLAP interface when the first user feature query request does not include the user identifier. It can be understood that, when the first user feature query request includes a user identifier, it can generally be determined that the first user feature query request is used to query the user feature of the user corresponding to the user identifier, and then it can be determined that the query result includes a small amount of data. In combination with the above description of the OLTP interface and the OLAP interface, the query interface can be selected as the OLTP interface. This embodiment based on the OLTP interface can support a second-level query of a user feature value, aggregate counting of feature values, and second-level metadata query and return. Similarly, when the first user feature query request does not include the user identifier, it can generally be determined that the first user feature query request is used to query a more complex user feature, such as all users who have logged in to the application 1 in the last three days, then the query interface can be selected as the OLAP interface. In this way, the server can select an appropriate query interface based on the user feature query request to improve the data query efficiency and data query reliability, thereby improving the reliability and efficiency of generating the user profile.

By way of example, it is assumed that the first user feature query request is used to query the user feature 1 in the target database: an age of the user 1, and the first user feature query request includes a user identifier 1 of the user 1. Then, in response to receiving the first user feature query request, the server can determine that the first user feature query request includes the user identifier 1 of the user 1, and the server can select the query interface corresponding to the first user feature query request as the OLTP interface. In the above way, it can support anchoring multi-type crowd data through profiles and realize diversified delivery requirements, such as setting real-time crowd tags, searching routine or static user groups, etc. In this case, it can support a more flexible crowd anchoring approach, and a gateway layer can translate more types of SQL statements. For example, it supports a real-time data query in a dynamic range, and the business can use profile underlying feature data more flexibly at a front end.

By way of example, the server can determine whether the user satisfies a certain condition through the OLTP interface, and then deliver a corresponding advertisement pop-up window to the user satisfying the condition. For example, it is assumed that the first user feature query request is used to query the user feature 2 in the target database: whether the user 2 opens an account, and the first user feature query request includes a user identifier 2 of the user 2. Then, in response to receiving the first user feature query request, the server can determine that the first user feature query request includes the user identifier 2 of the user 2, and can select the query interface corresponding to the first user feature query request as the OLTP interface. In addition, the server can return “true” to the terminal in response to querying that the user feature 2 is that the user 2 has opened an account, and return “false” to the terminal in response to querying that the user feature 2 is that the user 2 has not opened an account. In addition, the server can recommend a pop-up advertisement for opening an account to the user 2 in response to confirming that the user feature 2 is that the user 2 has not opened an account.

By way of example, when a new stock opens, in this embodiment, a query matching is performed by acquiring self-select stock information or attention information authorized by the user, and for users who have the self-select stock in a self-select stock list, the full user population of “user self-select stock list=xxxx” is extracted for pushing information of the new stock opening.

By way of example, the server can determine a user who meets a certain condition through the OLAP interface, and push a corresponding message to the user. For example, it is assumed that the first user feature query request is used to query a user feature 3 in the target database: an active user, which refers to a user who has logged in within the last three days. In response to receiving the first user feature query request, the server can determine that the first user feature query request does not include the user identifier, and then the server can select the query interface corresponding to the first user feature query request as the OLAP interface. The server can determine all active users through the OLAP interface, and push messages to them.

By way of example, the user feature in this embodiment can further include a list of blocked users, a list of blacklisted users, self-select information, a list of stocks especially concerned, etc. When the user accesses a NiuNiu Circle, the system can filter recommended content based on the first two features, and use the latter two features to recommend related posts to the user.

By way of example, the server can query a plurality of user features of a certain user through the OLTP interface, and then analyze an interest preference of the user in combination with the plurality of user features to recommend information articles of interest to the user. The user features can include subscription information, holding information, and so on. For instance, it is assumed that a first user feature query request 1 is used to query a user feature 4 in the target database: whether the user 4 pays attention to or holds the stock 1. A first user feature query request 2 is used to query a user feature 5 in the target database: whether the user 4 pays attention to the stock 2. In response to receiving the first user feature query request 1 and the first user feature query request 2, the server can determine that both include user identifiers of the user 4. Consequently, the server can select query interfaces corresponding to the above two first user feature query requests as the OLTP interfaces. Then, the server can query that the user feature 4 is that the user 4 pays attention to the stock 1, and the user feature 5 is that the user 4 does not pay attention to the stock 2. The server can analyze that the user 4 has one interest preference of being interested in the stock 1 but not interested in the stock 2. Therefore, the server can recommend information articles, announcements, related posts, news, forums, etc. related to the stock 1 to the user 4.

By way of example, the server can determine whether a user satisfies a certain condition through the OLTP interface, and then issue a corresponding reward to the user who satisfies the condition. For instance, it is assumed that the first user feature query request is used to query a user feature 6 in the target database: whether User 6 has made a deposit, and the first user feature query request includes a user identifier 6 of the user 6. In response to receiving the first user feature query request, the server can determine that the first user feature query request includes the user identifier 6 of the user 6, and then the server can select the query interface corresponding to the first user feature query request as the OLTP interface. In addition, the server can issue a deposit reward to the user 6 in response to querying that the user feature 6 is that the user 6 has deposited.

By way of example, different users have different stock market permissions. For instance, users with high assets have higher stock market browsing permissions, while users without accounts only have specified stock market browsing permissions. Therefore, the server can control the stock market browsing permissions of users by determining user features: whether the user's assets meet specific criteria. For example, it is assumed that the first user feature query request is used to query a user feature 7 in the target database: whether a user 7's assets are RMB 10,000. In response to receiving the first user feature query request, the server can determine that the first user feature query request includes a user identifier 7 of the user 7, and then the server can select the query interface corresponding to the first user feature query request as the OLTP interface. The server can query that the user feature 7 is that the user 7's assets have reached RMB 10,000, and opens permission for the user 7 to view the market information for a stock 7.

In some implementations, the server can determine whether an abnormal user feature exists in the target database. When the abnormal user feature exists in the target database, the server can generate prompt information and push the prompt information to prompt the user that the abnormal user feature exists in the target database. When no abnormal user feature exists in the target database, the server cannot generate prompt information, thereby ensuring the accuracy of the user feature stored in the target database, improving the accuracy of the data query result, and further improving the accuracy and efficiency of generating the user profile.

By way of example, the server can establish a profile monitoring module to establish feature models for different user features or user profiles to determine whether the abnormal user feature exists in the target database, that is, to perform monitoring and alarm. For example, in response to determining whether the abnormal user feature exists in the target database, the server can acquire a first user feature stored in the target database at any moment and at least one second user feature within a predetermined duration before the any moment. Then the server can perform a statistical analysis on the at least one second user feature to obtain a distribution range of the first user feature. When the first user feature is not within the distribution range, the server can determine that the abnormal user feature exists in the target database, and when the first user feature is within the distribution range, the server can determine that no abnormal user feature exists in the target database. For example, the server can obtain the first user feature stored in the target database at 24:00 on Jun. 30, 2022: the number of users who logged in to the application 1 on Jun. 30, 2022, in which the first user feature is a. The server can acquire two second user features within two days before 24:00 on Jun. 30, 2022: a second user feature 1 and a second user feature 2. The two second user features are respectively: the number of users who logged in to the application 1 on Jun. 29, 2022, and the number of users who logged in to the application 1 on Jun. 28, 2022, in which the second user feature 1 and the second user feature 2 are b and c, respectively. The server can calculate an average value of the second user feature 1 and the second user feature 2 as (b+c)/2=d, and then the server can determine (d−e, d+e) as a distribution range of the first user feature. When the first user feature a is within the distribution range (d−e, d+e), it can be determined that the first user feature is normal data, that is, it can be determined that no abnormal user feature exists in the target database. When the first user feature a is not within the distribution range (d−e, d+e), it can be determined that the first user feature is abnormal data, that is, it can be determined that the abnormal user feature exits in the target database, in which a, b, c, d, e are positive integers.

It can be understood that, since a link of a user profile production process is relatively long, and a migration of service data or a change of data source easily results in inaccurate user data obtained, thus resulting in the inaccurate user profile, it is necessary to monitor and alert the user feature or user profile. For example, the user data can be acquired by the server from other databases, such as a service source database that records user data such as a user stock account opening status and a user login status. When the user data stored in the other databases is changed, such as a storage location of the user data is changed, the user data acquired by the server is inaccurate, which further results in the inaccurate generated user feature, resulting in the inaccurate data query result. Therefore, by determining whether the abnormal user feature exists in the target database, the accuracy of the user feature stored in the target database can be ensured, a calculation and change speed of user feature data is optimized, allowing a real-time stream calculation to be performed more quickly based on the service data. At present, more than 90% of the user features support a second-level real-time update, to improve the accuracy of the data query result and further improve the accuracy and efficiency of generating the user profile.

In some implementations, as shown in FIG. 1, it is assumed that the application 1 is mounted at the terminal 110, and the user queries the target user feature based on natural language by accessing the application 1. Subsequent to the user inputting the natural language for querying the target user feature on the application 1, the server can convert the natural language into the SQL, and query the target user feature in the target database based on the SQL. The server can pre-store a correspondence between the natural language and the SQL, and then convert the natural language into the SQL based on the correspondence. For example, as shown in Table 1, it is assumed that the server pre-stores a partial correspondence relationship between the natural language and the SQL as shown in Table 1. As shown in a second row of Table 1, the natural language “age” corresponds to the SQL “SQL1”.

TABLE 1

| Natural language | SQL |
|---|---|
| Age | SQL1 |
| = | SQL2 |
| 20 | SQL3 |
| And | SQL4 |
| Socialization days | SQL5 |
| 30 | SQL6 |

By way of example, as shown in FIG. 6, assuming that a natural language 1 inputted by the user on the application 1 is “age=20,” the terminal can send the natural language 1 to the server. In response to receiving the natural language 1, the server can convert the natural language 1 into the corresponding SQL “SQL1, SQL2, SQL3” based on the above Table 1.

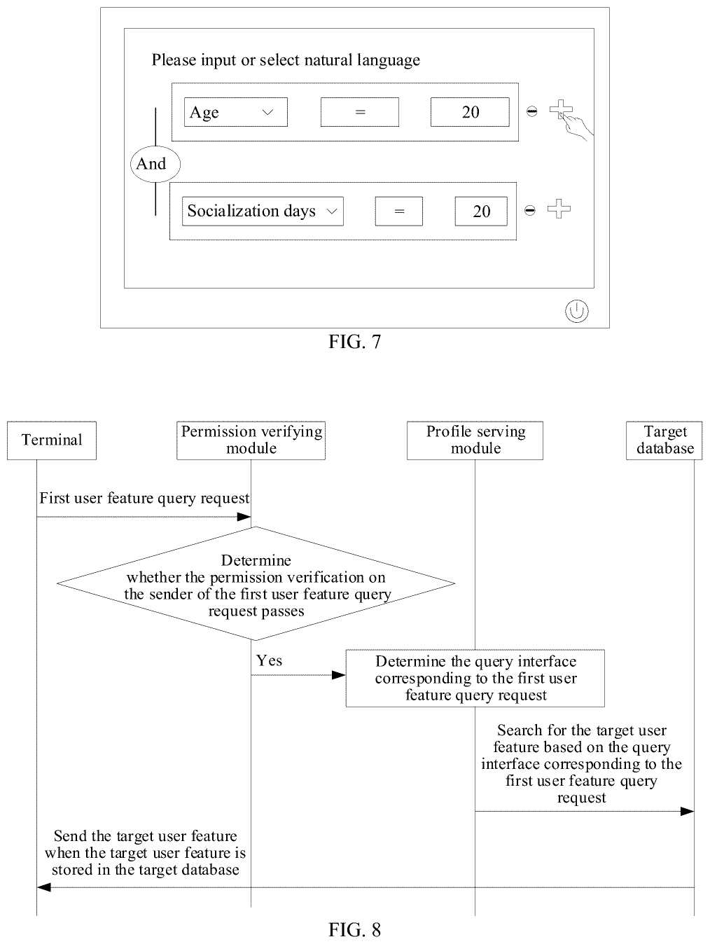

By way of example, as shown in FIG. 7, there is a plus button after the natural language 1 “age=20”. After the user clicks the plus button, the user may continue to input a natural language 2 “social days=20”, and the relationship between the input natural language 2 and natural language 1 is shown as “and” in FIG. 4, indicating that the user wishes to query “users with age=20 and social days=20”. Then, the server can translate the natural languages inputted by the user to the corresponding SQL “SQL1, SQL2, SQL3, SQL4, SQL5, SQL2, SQL3”.

It should be understood that the present disclosure is only schematic with respect to the correspondence between the natural language and the SQL, and a conversion of the natural language to the corresponding SQL is also schematic.

In some implementations, as shown in FIG. 8, the server can include a permission verifying module, a profile serving module, and a target database. The terminal can send the first user feature query request to the server to query the target user feature. In response to receiving the first user feature query request, the server can first perform the permission verification on the sender of the first user feature query request based on the above permission verifying module. When the permission verification on the sender passes, in response to the first user feature query request, the server can determine the query interface corresponding to the first user feature query request based on the profile serving module, and then search the target database for the target user feature in response to the first user feature query request based on the query interface corresponding to the first user feature query request. When the target user feature is stored in the target database, the server can send the target user feature to the terminal.

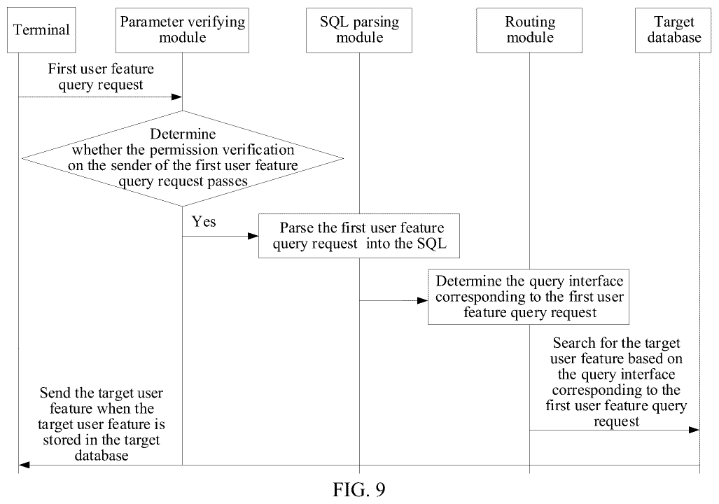

In some implementations, as shown in FIG. 9, the server can include a parameter verifying module, an SQL parsing module, a routing module, and a target database. The terminal can send the first user feature query request to the server to query the target user feature, and the first user feature query request can be in the natural language. In response to receiving the first user feature query request, the server can first perform the permission verification on the sender of the first user feature query request based on the parameter verifying module. When the permission verification on the sender passes, in response to the first user feature query request, the first user feature query request in the natural language can be parsed into a first user feature query request in the SQL based on the SQL parsing module. The server can determine the query interface corresponding to the first user feature query request based on the routing module. Then, in response to the first user feature query request and based on the query interface corresponding to the first user feature query request, the server can determine whether the target user feature is stored by searching in the target database. When the target user feature is stored in the target database, the server can send the target user feature to the terminal.

To sum up, the technical solutions of the above embodiments bring at least the following beneficial effects. Through the technical solution of the present disclosure, the server can first acquire the plurality of pieces of user data and the generation time of the last piece of user data among the plurality of pieces of user data. Each time a piece of first user data is read from the plurality of pieces of user data, the server can generate the user feature corresponding to the first user data. When the generation time of the first user data is consistent with the generation time of the last piece of user data, the server can store the user feature corresponding to the first user data into the target database. When the generation time of the first user data is inconsistent with the generation time of the last piece of user data, the server may not store the user feature corresponding to the first user data into the target database. Finally, the server can generate the user profile based on the user feature in the target database. In the above process, the server can determine whether a currently read user data is the last piece of user data by determining whether a generation time of the currently read user data is consistent with the generation time of the last piece of user data. Therefore, only the user feature corresponding to the last piece of user data may be stored in the target database, and a user feature corresponding to other user data may not be stored in the target database. Then, in response to querying the user feature, such as querying the user feature when the server reads the user data, a query result will not be the user feature corresponding to other user data, but only a user feature corresponding to a last piece of original user data, that is, a final user feature calculated based on all user data. In this way, the server can generate a correct user profile based on the final user feature to solve the problem in the related art of inaccurate user feature query caused by data storage and the inaccurate user profile generated based on the queried user feature. Therefore, the accuracy of the user feature query can be improved, thereby improving the efficiency and accuracy of the application of the user profile.

Furthermore, in response to receiving the first user feature query request, the server can determine whether the target user feature is stored by searching in the target database in response to the first user feature query request. When the target user feature is not stored in the target database, and the target user feature is composed of the plurality of sub-user features in the target database, the server can decompose the target user feature into the plurality of sub-user features, and perform the data query based on the plurality of sub-user features. In this way, the server does not need to generate the target user feature, and the target database only needs to store the sub-user features. When the server receives the first query request, the server can determine the target user feature based on the sub-user features, thereby reducing the calculation cost of the server and the storage cost of the target database.

Furthermore, in response to receiving the first user feature query request sent by the terminal, the server can convert, in response to the first user feature query request, the first user feature query request into the second user feature query request with the same meaning as the first user feature query request. Then, in response to the second user feature query request, the server can determine whether the target user feature is stored by searching in the target database. In this way, when the server does not find the user feature corresponding to the first user feature query request in the target database, the server can search the target database for the corresponding user feature based on the second user feature query request with the same meaning as the first user feature query request. When the user feature corresponding to the second user feature query request is stored in the target database, the server can send the user feature corresponding to the second user feature query request to the terminal. Therefore, the query efficiency can be improved, and the efficiency of generating the user profile can be improved.

Furthermore, prior to determining, in response to the first user feature query request, whether the target user feature is stored by searching in the target database, the server can further perform the permission verification on the sender of the first user feature query request. When the permission verification on the sender passes, the server can determine whether the target user feature is stored by searching in the target database in response to the first user feature query request, to improve the security of the data query and the security of generating the user profile.

Furthermore, prior to determining, in response to the first user feature query request, whether the target user feature is stored by searching in the target database, the server can further determine the query interface corresponding to the first user feature query request, and then determine, in response to the first user feature query request and based on the query interface corresponding to the first user feature query request, whether the target user feature is stored by searching in the target database. In this way, the server can select an appropriate query interface based on the user feature query request, to improve the efficiency and reliability of data query and improve the efficiency and reliability of generating the user profile.

Furthermore, the server can determine whether the abnormal user feature exists in the target database. When the abnormal user feature exists in the target database, the server can generate the prompt information and push the prompt information to prompt the user that the abnormal user feature exists in the target database. When no abnormal user feature exists in the target database, the server may not generate the prompt information, to ensure the accuracy of the user feature stored in the target database, improve the accuracy of the data query result, and improve the accuracy of generating the user profile.

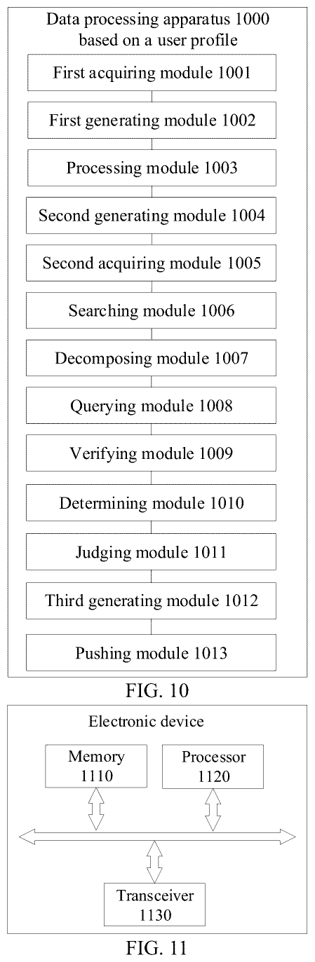

FIG. 10 is a schematic diagram of a data processing apparatus 1000 based on a user profile according to an embodiment of the present disclosure. As shown in FIG. 10, the apparatus 1000 includes a first acquiring module 1001, a first generating module 1002, a processing module 1003, and a second generating module 1004. The first acquiring module 1001 is configured to acquire a plurality of pieces of user data and a generation time of a last piece of user data among the plurality of pieces of user data. The first generating module 1002 is configured to generate, each time a piece of first user data is read from the plurality of pieces of user data, a user feature corresponding to the first user data. The processing module 1003 is configured to: store the user feature corresponding to the first user data into a target database when a generation time of the first user data is consistent with the generation time of the last piece of user data; and not store the user feature corresponding to the first user data into the target database when the generation time of the first user data is inconsistent with the generation time of the last piece of user data. The second generating module 1004 is configured to generate a user profile based on the user feature in the target database.

In some implementations, the apparatus 1000 further includes a second acquiring module 1005, a searching module 1006, a decomposing module 1007, and a querying module 1008. The second acquiring module 1005 is configured to acquire the first user feature query request. The searching module 1006 is configured to determine whether the target user feature is stored by searching in the target database in response to the first user feature query request. The decomposing module 1007 is configured to decompose the target user feature into the plurality of sub-user features when the target user feature is not stored in the target database and the target user feature is composed of the plurality of sub-user features in the target database. The querying module 1008 is configured to perform the data query based on the plurality of sub-user features.

In some implementations, the searching module 1006 is specifically configured to convert, in response to the first user feature query request, the first user feature query request into the second user feature query request with the same meaning as the first user feature query request, and determine, in response to the second user feature query request, whether the target user feature is stored by searching in the target database.

In some implementations, the apparatus 1000 further includes a verifying module 1009. The verifying module 1009 is configured to perform the verification permission on the sender of the first user feature query request. The searching module 1006 is specifically configured to determine, when the permission verification on the sender passes and in response to the first user feature query request, whether the target user feature is stored by searching in the target database.

In some implementations, the verifying module 1009 is specifically configured to: acquire the identifier of the sender; determine the permission range of the sender based on the identifier of the sender; determine that the permission verification on the sender passes, when the permission range of the sender includes the permission to query the target user feature; and determine that the permission verification on the sender fails, when the permission range of the sender does not include the permission to query the target user feature.

In some implementations, the apparatus 1000 further includes a determining module 1010. The determining module 1010 is configured to determine the query interface corresponding to the first user feature query request. The searching module 1006 is specifically configured to determine, in response to the first user feature query request and based on the query interface corresponding to the first user feature query request, whether the target user feature is stored by searching in the target database.

In some implementations, the determining module 1010 is specifically configured to determine that the query interface corresponding to the first user feature query request is the OLTP interface when the first user feature query request includes the user identifier, and determine that the query interface corresponding to the first user feature query request is the OLAP interface when the first user feature query request does not include the user identifier.

In some implementations, the apparatus 1000 further includes a judging module 1011, a third generating module 1012, and a pushing module 1013. The judging module 1011 is configured to determine whether the abnormal user feature exists in the target database. The third generating module 1012 is configured to generate the prompt information when the abnormal user feature exists in the target database. The pushing module 1013 is configured to push the prompt information to prompt the user that the abnormal user feature exists in the target database.

In some implementations, the judging module 1011 is specifically configured to: acquire the first user feature stored at any moment and at least one second user feature within the predetermined duration before the any moment in the target database; perform a statistical analysis on the at least one second user feature to obtain the distribution range of the first user feature; determine that the abnormal user feature exists in the target database when the first user feature is not within the distribution range; and determine that no abnormal user feature exists in the target database when the first user feature is within the distribution range.

In some implementations, the first generating module 1003 is specifically configured to: select, each time a piece of the first user data is read from the plurality of pieces of user data, the generation approach for the user feature corresponding to the first user data based on the calculation caliber and the application scenario, the generation approach being the stream generation approach or the batch generation approach; and generate the user feature corresponding to the first user data based on the generation approach for the user feature corresponding to the first user data.

It should be understood that the apparatus embodiments may correspond to the method embodiments, and reference may be made to the method embodiments for similar description of the apparatus embodiments, and thus details thereof will be omitted here to avoid repetition. Specifically, the apparatus 1000 shown in FIG. 10 can perform the method embodiments described above, and the above and other operations and/or functions of each of modules in the apparatus 1000 are respectively configured to perform the method embodiments, and thus details thereof will be omitted here for conciseness.

The apparatus 1000 according to the embodiments of the present disclosure is described above from the perspective of functional modules in conjunction with the accompanying drawings. It should be understood that the functional modules may be implemented in a form of hardware, by instructions in a form of software, or by a combination of hardware and software modules. Specifically, steps of the method embodiments of the present disclosure may be implemented by hardware integrated logic circuits in a processor and/or instructions in the form of software. The steps of the method that are disclosed in combination with the embodiments of the present disclosure may be directly embodied as being executed by a hardware decoding processor, or executed by a combination of hardware and software modules in the decoding processor. Optionally, the software module may be located in a mature storage medium in the art such as a random access memory, a flash memory, a Read-Only Memory (ROM), a Programmable ROM (PROM), an electrically erasable programmable memory, and a register. The storage medium is located in a memory. The processor reads information from the memory, and completes the steps in the above method embodiments in combination with hardware thereof.

FIG. 11 is a schematic block diagram showing an electronic device according to an embodiment of the present disclosure.

As illustrated in FIG. 11, the electronic device may include a memory 1110 and a processor 1120. The memory 1110 is configured to store a computer program and transmit codes of the computer program to the processor 1120. That is, the processor 1120 can invoke and execute the computer program from the memory 1110 to implement the method according to the embodiments of the present disclosure.

For example, the processor 1120 is configured to perform the above method embodiments based on instructions in the computer program.

In some embodiments of the present disclosure, the processor 1120 may include, but is not limited to, a general-purpose processor, a Digital Signal Processor (DSP), an Application Specific Integrated Circuit (ASIC), a Field Programmable Gate Array (FPGA), or another programmable logic device, a discrete gate or a transistor logic device, a discrete hardware component, etc.

In some embodiments of the present disclosure, the memory 1110 may include, but is not limited to, a volatile memory and/or a non-volatile memory. Here, the non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustration rather than limitation, RAMs in many forms are available, e.g., a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DR RAM).

In some embodiments of the present disclosure, the computer program may be divided into one or more modules. The one or more modules may be stored in the memory 1110 and executed by the processor 1120 to complete the method provided by the present disclosure. The one or more modules may be a series of computer program instruction segments capable of completing specific functions. The instruction segments are used to describe an execution process of the computer program in the electronic device.

As illustrated in FIG. 11, the electronic device may further include a transceiver 1130 connectable to the processor 1120 or the memory 1110.

Here, the processor 1120 may control the transceiver 1130 to communicate with other devices, specifically, to transmit information or data to other devices, or receive information or data transmitted from other devices. The transceiver 1130 may include a transmitter and a receiver. The transceiver 1130 may further include one or more antennas.

It should be understood that various components in the electronic device are connected to each other via a bus system. Here, in addition to a data bus, the bus system also includes a power bus, a control bus, and a status signal bus.

The present disclosure further provides a computer storage medium. The computer storage medium has a computer program stored thereon. The computer program, when executed by a computer, causes the computer to perform the method according to the above method embodiments. Or, the embodiments of the present disclosure further provide a computer program product including instructions. The instructions, when executed by a computer, cause the computer to perform the method according to the above method embodiments.

When implemented by software, the above embodiments can be entirely or partially implemented in the form of a computer program product. The computer program product includes one or more computer instructions. When the computer program instructions are loaded and executed on a computer, the processes or functions described in the embodiments of the present disclosure are provided in whole or in part. The computer may be a general purpose computer, an application specific computer, a computer network, or any other programmable device. The computer instructions may be stored in a computer-readable storage medium or transmitted from one computer-readable storage medium to another computer-readable storage medium. For example, the computer instructions may be transmitted from one website, computer, server, or data center to another website, computer, server, or data center via a wired manner (such as a coaxial cable, an optical fiber, a Digital Subscriber Line (DSL)) or a wireless manner (such as infrared, wireless, microwave, etc.). The computer-readable storage medium may be any usable medium that can be accessed by a computer or a data storage device such as a server or a data center integrated with one or more usable medium. The usable medium may be a magnetic medium (for example, a floppy disk, a hard disk, a magnetic tape), an optical medium (for example, a Digital Video Disc (DVD)), or a semiconductor medium (for example, a Solid State Disk (SSD)), etc.

It can be appreciated by those of ordinary skill in the art that the modules and the steps of the algorithm of various examples described in combination with the embodiments disclosed herein may be implemented in electronic hardware or a combination of computer software and electronic hardware, which depends on specific applications and design constraint conditions of technical solutions. For each specific application, professionals and technicians can use different methods to implement the described functions, and such an implementation should not be considered as going beyond the scope of the present disclosure.

In several embodiments provided by the present disclosure, it should be understood that the disclosed systems, apparatuses and methods can be implemented in other ways. For example, the apparatus embodiments described above are merely exemplary. For example, the modules are merely divided based on logic functions. In practical implementation, the modules may be divided in other manners. For example, multiple modules or components may be combined or integrated into another system, or some features may be omitted or not executed. In addition, mutual coupling or direct coupling or communication connection displayed or discussed may be implemented as indirect coupling or communication connection via some interfaces, apparatuses or modules, and may be electrical, mechanical or in other forms.

The modules illustrated as separate components may be or not be separated physically, and components shown as modules may be or not be physical modules, i.e., may be located at one position, or distributed onto multiple network units. It is possible to select some or all of the modules according to actual needs, for achieving the objective of the embodiments of the present disclosure. For example, respective functional modules in respective embodiments of the present disclosure may be integrated into one processing module, or may be present as separate physical entities. It is also possible to integrate two or more modules into one module.

The above description merely illustrates specific implementations of the present disclosure, and the scope of the present disclosure is not limited thereto. Change or replacement within the technical scope disclosed by the present disclosure that can be easily conceived by those skilled in the art shall fall within the scope of the present disclosure. Thus, the scope of the present disclosure should be defined by claims.

What is claimed is:

1. A data processing method based on a user profile, the method comprising:
acquiring a plurality of pieces of user data and a generation time of a last piece of user data among the plurality of pieces of user data;
generating, each time a piece of first user data is read from the plurality of pieces of user data, a user feature corresponding to the first user data;
storing the user feature corresponding to the first user data into a target database when a generation time of the first user data is consistent with the generation time of the last piece of user data;
not storing the user feature corresponding to the first user data into the target database when the generation time of the first user data is inconsistent with the generation time of the last piece of user data; and
generating a user profile based on the user feature in the target database.

2. The method according to claim 1, further comprising:
acquiring a first user feature query request;
determining, in response to the first user feature query request, whether a target user feature is stored by searching in the target database;
decomposing the target user feature into the plurality of sub-user features when the target user feature is not stored in the target database and the target user feature is composed of a plurality of sub-user features in the target database; and
performing a user feature query based on the plurality of sub-user features.

3. The method according to claim 2, wherein said determining, in response to the first user feature query request, whether the target user feature is stored by searching in the target database comprises:
converting, in response to the first user feature query request, the first user feature query request into a second user feature query request with a same meaning as the first user feature query request; and
determining, in response to the second user feature query request, whether the target user feature is stored by searching in the target database.

4. The method according to claim 2, further comprising, prior to said determining, in response to the first user feature query request, whether the target user feature is stored by searching in the target database:
performing permission verification on a sender of the first user feature query request,
wherein said determining, in response to the first user feature query request, whether the target user feature is stored by searching in the target database comprises:
when the permission verification on the sender passes, determining, in response to the first user feature query request, whether the target user feature is stored by searching in the target database.

5. The method according to claim 4, wherein said performing the permission verification on the sender of the first user feature query request comprises:
acquiring an identifier of the sender;
determining a permission range of the sender based on the identifier of the sender;
determining that the permission verification on the sender passes, when the permission range of the sender comprises permission to query the target user feature; and
determining that the permission verification on the sender fails, when the permission range of the sender does not comprise the permission to query the target user feature.

6. The method according to claim 2, further comprising, prior to said determining, in response to the first user feature query request, whether the target user feature is stored by searching in the target database:
determining a query interface corresponding to the first user feature query request,
wherein said determining, in response to the first user feature query request, whether the target user feature is stored by searching in the target database comprises:
determining, in response to the first user feature query request and based on the query interface corresponding to the first user feature query request, whether the target user feature is stored by searching in the target database.

7. The method according to claim 6, wherein said determining the query interface corresponding to the first user feature query request comprises:
determining that the query interface corresponding to the first user feature query request is an On-Line Transaction Processing (OLTP) interface, when the first user feature query request comprises a user identifier; and
determining that the query interface corresponding to the first user feature query request is an On-Line Analytical Processing (OLAP) interface, when the first user feature query request does not comprise the user identifier.

8. The method according to claim 1, further comprising:
determining whether an abnormal user feature exists in the target database;
generating prompt information when the abnormal user feature exists in the target database; and
pushing the prompt information to prompt the user that the abnormal user feature exists in the target database.

9. The method according to claim 8, wherein said determining whether the abnormal user feature exists in the target database comprises:
acquiring a first user feature stored in the target database at any moment and at least one second user feature within a predetermined duration before the any moment;
performing a statistical analysis on the at least one second user feature to obtain a distribution range of the first user feature;
determining that the abnormal user feature exists in the target database when the first user feature is not within the distribution range; and
determining that no abnormal user feature exists in the target database when the first user feature is within the distribution range.

10. The method according to claim 1, wherein said generating, each time a piece of the first user data is read from the plurality of pieces of user data, the user feature corresponding to the first user data comprises:
selecting, each time a piece of the first user data is read from the plurality of pieces of user data, a generation approach for the user feature corresponding to the first user data based on a calculation caliber and an application scenario, the generation approach being a stream generation approach or a batch generation approach; and
generating the user feature corresponding to the first user data based on the generation approach for the user feature corresponding to the first user data.

11. An electronic device, comprising:
a memory configured to store a computer program; and
a processor configured to invoke and execute the computer program stored in the memory to perform a data processing method based on a user profile, the method comprising:
acquiring a plurality of pieces of user data and a generation time of a last piece of user data among the plurality of pieces of user data;
generating, each time a piece of first user data is read from the plurality of pieces of user data, a user feature corresponding to the first user data;
storing the user feature corresponding to the first user data into a target database when a generation time of the first user data is consistent with the generation time of the last piece of user data;
not storing the user feature corresponding to the first user data into the target database when the generation time of the first user data is inconsistent with the generation time of the last piece of user data; and
generating a user profile based on the user feature in the target database.

12. The electronic device according to claim 11, wherein the processor is further configured to invoke and execute the computer program stored in the memory to perform following operations:
acquiring a first user feature query request;
determining, in response to the first user feature query request, whether a target user feature is stored by searching in the target database;
decomposing the target user feature into the plurality of sub-user features when the target user feature is not stored in the target database and the target user feature is composed of a plurality of sub-user features in the target database; and
performing a user feature query based on the plurality of sub-user features.

13. The electronic device according to claim 12, wherein said determining, in response to the first user feature query request, whether the target user feature is stored by searching in the target database comprises:
converting, in response to the first user feature query request, the first user feature query request into a second user feature query request with a same meaning as the first user feature query request; and
determining, in response to the second user feature query request, whether the target user feature is stored by searching in the target database.

14. The electronic device according to claim 12, wherein the processor is further configured to invoke and execute the computer program stored in the memory to perform following operations, prior to said determining, in response to the first user feature query request, whether the target user feature is stored by searching in the target database:
performing permission verification on a sender of the first user feature query request,
wherein said determining, in response to the first user feature query request, whether the target user feature is stored by searching in the target database comprises:
when the permission verification on the sender passes, determining, in response to the first user feature query request, whether the target user feature is stored by searching in the target database.

15. The electronic device according to claim 14, wherein said performing the permission verification on the sender of the first user feature query request comprises:
acquiring an identifier of the sender;
determining a permission range of the sender based on the identifier of the sender;
determining that the permission verification on the sender passes, when the permission range of the sender comprises permission to query the target user feature; and
determining that the permission verification on the sender fails, when the permission range of the sender does not comprise the permission to query the target user feature.

16. The electronic device according to claim 12, wherein the processor is further configured to invoke and execute the computer program stored in the memory to perform following operations, prior to said determining, in response to the first user feature query request, whether the target user feature is stored by searching in the target database:
determining a query interface corresponding to the first user feature query request,
wherein said determining, in response to the first user feature query request, whether the target user feature is stored by searching in the target database comprises:
determining, in response to the first user feature query request and based on the query interface corresponding to the first user feature query request, whether the target user feature is stored by searching in the target database.

17. The electronic device according to claim 16, wherein said determining the query interface corresponding to the first user feature query request comprises:
determining that the query interface corresponding to the first user feature query request is an On-Line Transaction Processing (OLTP) interface, when the first user feature query request comprises a user identifier; and
determining that the query interface corresponding to the first user feature query request is an On-Line Analytical Processing (OLAP) interface, when the first user feature query request does not comprise the user identifier.

18. The electronic device according to claim 11, wherein the processor is further configured to invoke and execute the computer program stored in the memory to perform following operations:
determining whether an abnormal user feature exists in the target database;
generating prompt information when the abnormal user feature exists in the target database; and
pushing the prompt information to prompt the user that the abnormal user feature exists in the target database.

19. A non-transitory computer-readable storage medium, having a computer program stored thereon, wherein the computer program causes a computer to perform a data processing method based on a user profile, the method comprising:
acquiring a plurality of pieces of user data and a generation time of a last piece of user data among the plurality of pieces of user data;
generating, each time a piece of first user data is read from the plurality of pieces of user data, a user feature corresponding to the first user data;
storing the user feature corresponding to the first user data into a target database when a generation time of the first user data is consistent with the generation time of the last piece of user data;
not storing the user feature corresponding to the first user data into the target database when the generation time of the first user data is inconsistent with the generation time of the last piece of user data; and
generating a user profile based on the user feature in the target database.

20. A computer program product, comprising an instruction, wherein the computer program product, when running on an electronic device, causes the electronic device to perform the method according to claim 1.
